(19) United States
(12) Patent Application Publication
(10) Pub. No.: US 2026/0138787 A1
(43) Pub. Date: May 21, 2026

(54) STORAGE MECHANISM WITH POSITIONING STRUCTURE AND STORAGE DEVICE

(71) Applicant: YUXIN XIAO, Shanghai (CN)

(72) Inventor: YUXIN XIAO, Shanghai (CN)

(21) Appl. No.: 19/032,159

(22) Filed: Jan. 20, 2025

(30) Foreign Application Priority Data
Nov. 20, 2024 (CN) 202411665807.7

(51) Int. Cl. B65D 25/10

(52) U.S. Cl. CPC B65D 25/108

(57) ABSTRACT

A storage mechanism with a positioning structure and a storage device are provided, the storage mechanism includes a plurality of installation plates, surfaces of the installation plates are uniformly distributed with a plurality of positioning blocks, and a positioning groove is provided on one side of the positioning blocks away from the installation plates; a storage unit including at least one storage block, a surface of the storage block is provided with a suspension part for hanging to-be-stored items and/or a storage part for storing the items, and at least one positioning protrusion for adapting to the positioning groove provided on one side of the storage block away from the suspension part and/or the storage part; the positioning protrusion and the positioning groove are detachably connected by a magnetic suction member, it is possible to store different items by replacing different storage blocks.

### CROSS-REFERENCE TO RELATED APPLICATIONS

This application claims priority to Chinese Patent Application No. 202411665807.7, filed on Nov. 20, 2024, which is hereby incorporated by reference in its entirety.

### TECHNICAL FIELD

The present disclosure relates to the field of storage device technologies, and in particular, to a storage mechanism with a positioning structure and a storage device.

### BACKGROUND

In daily life and work, with the increase of item types, in order to facilitate the classification and organization of items, as well as to facilitate searching and use, storage devices are usually needed to store items. There are various styles of existing storage devices, such as storage boxes, cabinets, and drawers that exist in the form of storage containers, as well as storage racks and frames fixed on desktops or walls.

At present, when storing tools and equipment, storage boxes on the market usually have openings inside the box that match the shape of the tools and equipment being stored, in order to achieve precise storage of the tools and equipment, and also facilitate searching and use. However, due to the fixed openings in the storage box, if individual tools and equipment need to be replaced separately, they cannot be placed, and the storage method is single and lacks flexibility.

### SUMMARY

The purpose of the present disclosure is to provide a storage mechanism with a positioning structure and a storage device for storing tools and equipment in the storage box of the prior art, which can only store tools and equipment that are consistent with the opening due to the fixed opening, the storage method is single and lacks flexibility.

The technical solution adopted by the storage mechanism with a positioning structure provided by the present disclosure is: a storage mechanism with a positioning structure, configured to store items in a vertical direction, including:
a plurality of installation plates, surfaces of the installation plates are evenly distributed a plurality of positioning blocks, and a positioning groove is provided on one side of the positioning blocks facing away from the installation plates;
a storage unit, including at least one storage block, where a surface of the storage block is provided with a suspension part configured to hang to-be-stored items and/or a storage part configured to store the to-be-stored items, and at least one positioning protrusion that is adapt to the positioning groove and provided on one side of the storage block away from the suspension part and/or the storage part; the positioning protrusion is detachably connected to the positioning groove through a magnetic suction member.

In some embodiments of the present disclosure, the magnetic suction member includes two sets of magnets respectively provided on the positioning blocks and the positioning protrusion; the two sets of magnets are arranged opposite to each other, where one set of magnets are uniformly distributed on a circumferential side of the positioning groove, and the other set of magnets are uniformly distributed on a circumferential side of the positioning protrusion.

In some embodiments of the present disclosure, the magnets are arranged in a cylindrical shape; opposite sides of the positioning blocks and the positioning protrusion are provided with magnet slots configured to accommodate the magnets.

In some embodiments of the present disclosure, the positioning groove is located at a center of the positioning blocks, and a cross-section of the positioning groove is gradually decreased from a groove mouth to an interior.

In some embodiments of the present disclosure, a support column is provided on the installation plates so that a gap is provided between the positioning blocks and the installation plates through the support column; a bent portion is provided on the storage block to cooperate with the gap.

In some embodiments of the present disclosure, the storage mechanism further includes a locking component configured to lock adjacent installation plates to achieve a splicing of the plurality of installation plates.

In some embodiments of the present disclosure, the locking component includes:
an installation seat, fixedly provided between adjacent four installation plates;
four contact plates, the installation seat is provided with sliding grooves that cooperate with the contact plates, so that the four contact plates are capable of being moved relative to the installation seat in a direction of approaching or moving away from each other, and the four contact plates are respectively configured to abut against the positioning blocks on the four installation plates; and
a rotating block, configured to drive the four contact plates to move towards or away from each other, so that the four contact plates are capable of being respectively abutted against side walls of the four positioning blocks; the rotating block is connected to a center of the installation seat through a screw thread, and a spiral disk is fixedly provided below the rotating block; at least one sliding block that cooperates with the gap of the spiral disk is provided on the contact plates;
by driving the rotating block to rotate, the spiral disk is driven to rotate, the sliding block is caused to slide within the gap of the spiral disk, thereby driving the four contact plates to move towards each other and respectively abut against the four positioning blocks, thus achieving the splicing of the plurality of installation plates.

In some embodiments of the present disclosure, the storage mechanism further includes a fixing component configured to fix the storage block, so that the storage block stores the to-be-stored items.

In some embodiments of the present disclosure, the fixing component includes:
a rotating column, which is vertically and rotatably provided on the installation plates;
a rotating groove, which is provided on a side wall of the rotating column for the positioning blocks to enter and achieve a limit of the positioning blocks;
a fixing hole, which is vertically provided on the storage block, the fixing hole penetrates the storage block and is configured for the rotating column to pass through; a top of the rotating column is protruded from a top surface of the storage block; a rotating head, which is fixedly provided at a top of the rotating column, located on a top surface of the storage block and configured to drive the rotating column to rotate.

In addition, the present application further provides a storage device including a storage container and the storage mechanism with a positioning structure as described above.

After adopting the above technical solution, the beneficial effects of the present disclosure are as following.

This application achieves a detachable connection between the storage block and the installation plates through a cooperation between the positioning protrusion on the storage block and the installation plates, as well as the magnetic force of the magnetic suction member. At this time, storage of items is achieved through the suspension part or storage part provided on the storage block. When other items need to be stored, an original storage block can be removed, and a suitable storage block can be installed to achieve the storage of the item. Different storage blocks can be replaced to store different items. The storage ways are diverse, and items can be stored in both vertical and planar directions, which is flexible, versatile, practical, and has good market promotion prospects.

### BRIEF DESCRIPTION OF DRAWINGS

In order to provide a clearer explanation of the embodiments of the present disclosure or the technical solutions in the prior art, a brief introduction will be given to the accompanying drawings required for the description of the embodiments or the prior art. It is obvious that the accompanying drawings described below are only some embodiments of the present disclosure. For those skilled in the art, other drawings can be obtained based on these drawings without creative work.

FIG. 1 is a display diagram of storing items in a vertical direction in an embodiment.

FIG. 2 is a schematic diagram used to illustrate a cooperative relationship between a positioning protrusion and positioning blocks in a first embodiment.

FIG. 3 is a display diagram of storing items in a plane direction in an embodiment.

FIG. 4 is a schematic diagram used to illustrate a cooperative relationship between the positioning protrusion and the positioning blocks in a second embodiment.

FIG. 5 is a schematic diagram used to illustrate an assembly relationship between a locking component and installation plates in the first and second embodiments.

FIG. 6 is a partial illustration of FIG. 5.

FIG. 7 is an exploded view of FIG. 6.

FIG. 8 is a schematic diagram used in an embodiment to illustrate a cooperative relationship between a fixing component, installation plates, and a storage block.

FIG. 9 is an exploded view of FIG. 8.

FIG. 10 is a schematic diagram used in an embodiment to illustrate a positional relationship between a storage container, a camera, and a storage unit.

Numeral reference: 100—installation plate; 101—support column; 110—positioning block; 120—positioning groove; 130—magnet; 200—storage unit; 210—storage block; 220—suspension part; 230—storage part; 240—positioning protrusion; 250—bent portion; 300—items; 400—locking component; 410—installation seat; 411—sliding groove; 420—contact plate; 421—sliding block; 430—rotating block; 440—spiral disk; 500—fixing component; 510—rotating column; 520—rotating groove; 530—fixing hole; 540—rotating head; 600—storage container.

### DESCRIPTION OF EMBODIMENTS

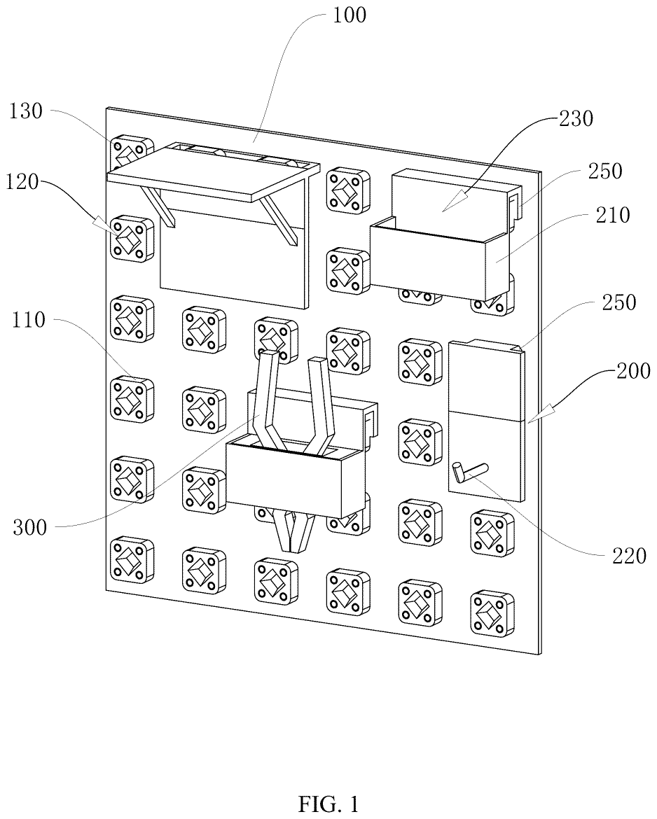

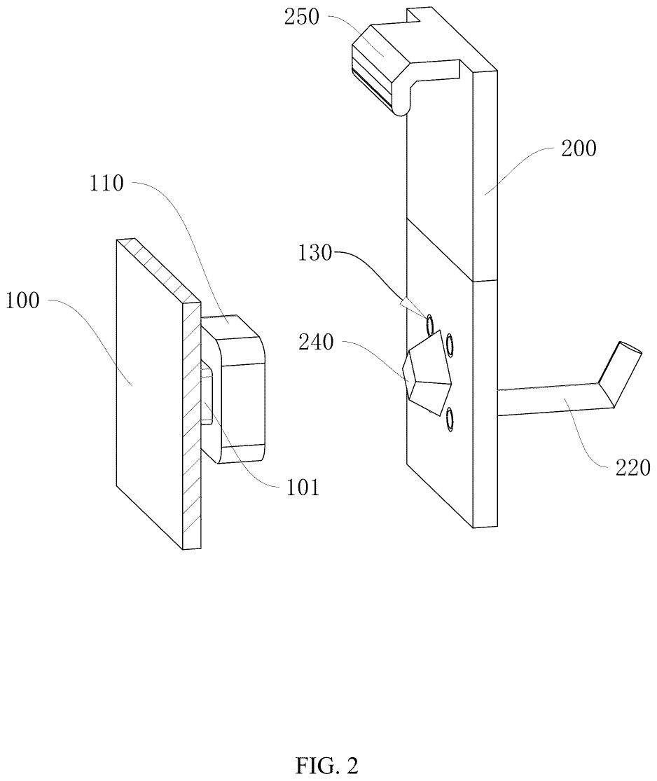

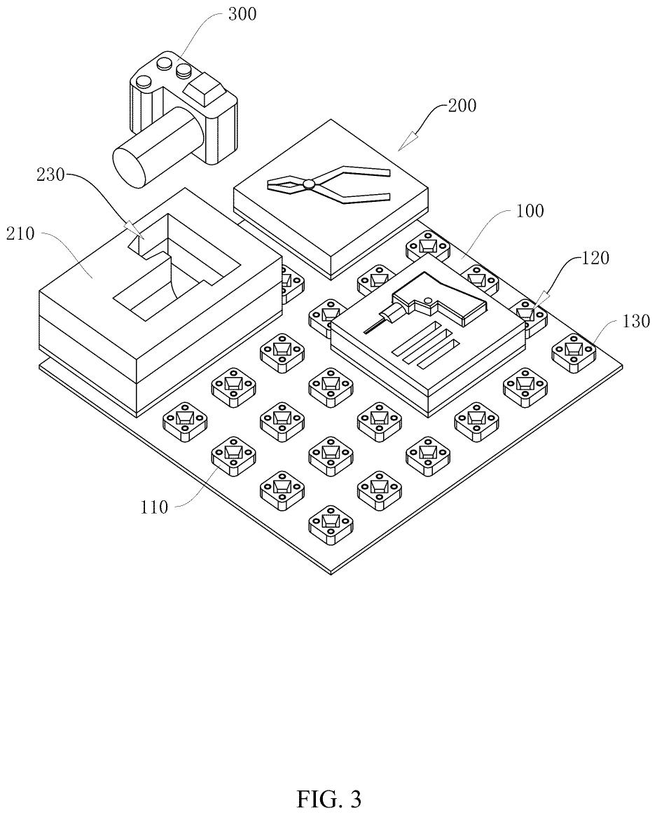

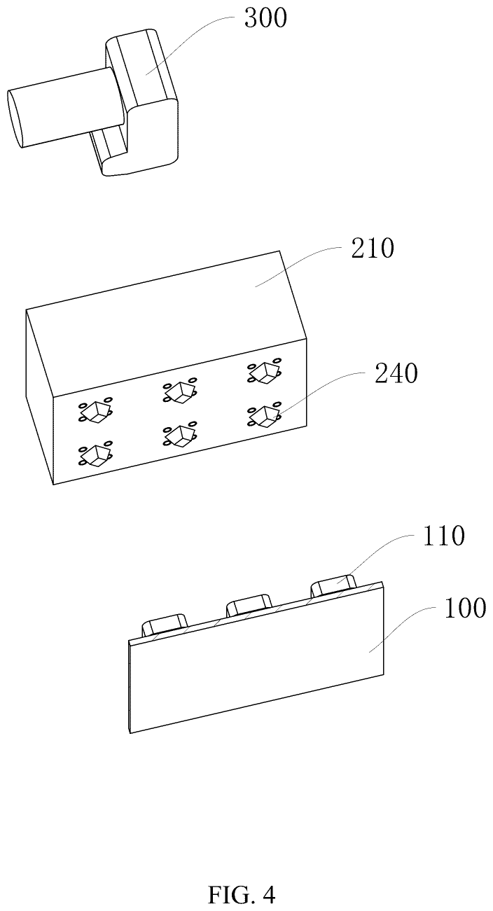

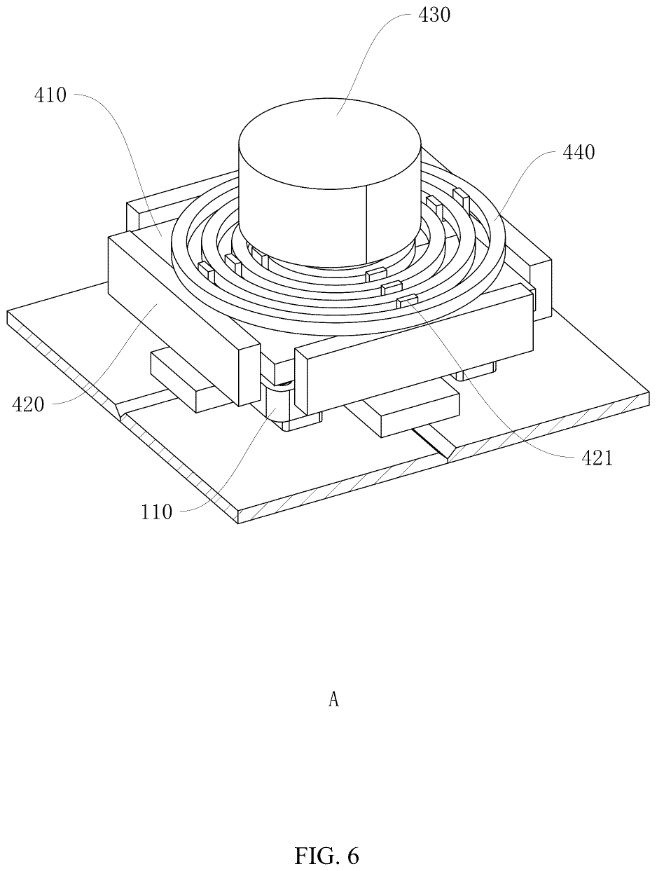

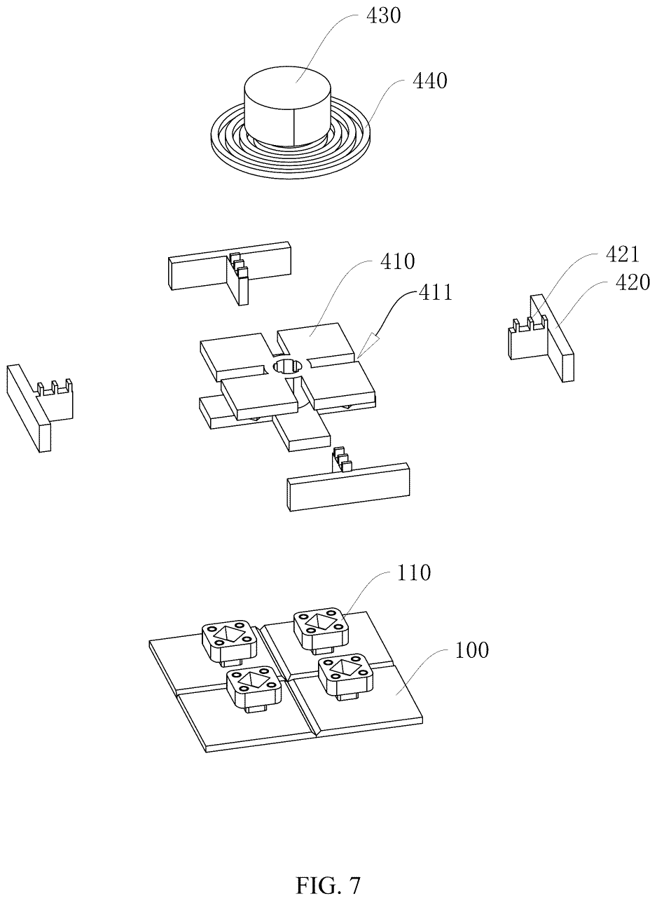

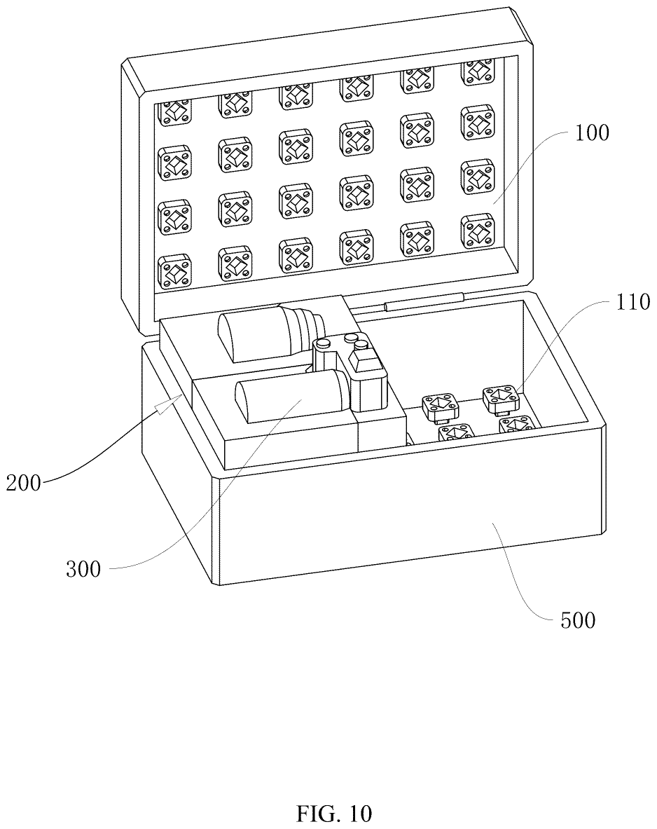

Below, the technical solutions in the embodiments of the present disclosure will be clearly and completely described in combination with FIGS. 1-10. Obviously, the described embodiments are only a part of the embodiments of the present disclosure, not all of them. Based on the embodiments of the present disclosure, all other embodiments obtained by those skilled in the art without creative work are within the protection scope of the present disclosure.

It should be noted that terms “center”, “longitudinal”, “transverse”, “up”, “down”, “front”, “back”, “left”, “right”, “top”, “bottom”, “inside”, “outside”, “rear”, “side”, “circumferential” and other directional or positional relationships indicated in the present disclosure are based on the directional or positional relationships shown in the accompanying drawings, only for a convenience of describing the present disclosure and simplifying the description, and do not indicate or imply that the device or element referred to must have a specific orientation, be constructed and operated in a specific orientation, and therefore cannot be understood as a limitation of the present disclosure. In addition, words such as “first” and “second” are only used to distinguish a plurality of components or structures with the same or similar structure, and do not indicate any special limitation on the order or connection relationship of the setting.

An embodiment relates to a unit type storage mechanism with a positioning structure, which can be applied to a storage container 600 such as a storage box, a storage cabinet, and a storage drawer, and can also be applied to a storage rack and frame to achieve storage and organization of items 300.

Referring to FIGS. 1-9, this storage mechanism with a positioning structure provided in this embodiment is configured to store the items 300 in a vertical direction and a planar direction, including a plurality of installation plates 100 and a storage unit 200. Surfaces of the installation plates 100 are uniformly distributed with a plurality of positioning blocks 110, one side of the positioning blocks 110 facing away from the installation plates 100 is provided with a positioning groove 120. The storage unit 200 includes at least one storage block 210, a surface of the storage block 210 is provided with a suspension part 220 configured to hang to-be-stored items 300 and/or a storage part 230 configured to store the items 300. One side of the storage block 210 facing away from the suspension part 220 and/or the storage part 230 is provided with at least one positioning protrusion 240 for adapting to the positioning groove 120. The positioning protrusion 240 is engaged and matched with the positioning groove 120; the positioning protrusion 240 and the positioning groove 120 are detachably connected through a magnetic suction member.

In this embodiment, there are two storage blocks 210. In an implementation mode, the number of the storage block 210 can also be set to other numbers. The storage blocks 210 can be individual or pieced together to form a whole, thereby achieving diversified storage.

When it is necessary to store items 300, the positioning protrusion 240 on the storage block 210 is inserted into the positioning groove 120 on the installation plates 100, and the magnetic suction member is provided to achieve positioning and fixing of the storage block 210. At this time, the suspension part 220 and/or the storage part 230 provided on the storage block 210 can be used to store items 300.

In addition, it should be noted that the number of the positioning protrusion 240 can be set one or more according to a size of the storage block 210. If the size of the storage block 210 is large, two or four positioning protrusions 240 can be set, and there is no further limitation here.

Furthermore, referring to FIGS. 1, 2, 3, and 4, the magnetic suction member includes two sets of magnets 130 respectively located on the positioning blocks 110 and the positioning protrusion 240. The two sets of magnets 130 are arranged opposite each other, one set of magnets 130 are evenly distributed on a circumferential side of the positioning groove 120 and the other set of magnets 130 are evenly distributed on a circumferential side of the positioning protrusion 240.

In this embodiment, the magnets 130 are arranged in a cylindrical shape, and magnet slots for accommodating the magnets 130 are provided on both the positioning blocks 110 and the positioning protrusion 240. The number of magnets 130 in each group of magnets 130 is four, and the four magnets 130 are evenly distributed on a circumferential side of the positioning groove 120. In an implementation mode, the shape, number, and distribution relationship of the magnets 130 can also be adjusted according to an actual situation, such as square, circular, rectangular, ring-shaped, etc. The number of magnets can be other numbers, and the distribution relationship can also be unevenly distributed on the circumferential side of the positioning groove 120, which can be adjusted according to the actual situation. There is no further limitations here.

Furthermore, the positioning groove 120 is located at a center of the positioning blocks 110, and a cross-section of the positioning groove 120 is gradually decreased inward from a groove mouth. Providing the positioning groove 120 at the center of the positioning blocks 110, so that the positioning protrusion 240 can render a connection between the storage block 210 and the positioning blocks 110 more stable when matched with the positioning groove 120. At the same time, providing the cross-section of the positioning groove 120 gradually decreasing from the groove mouth to the interior, so that the positioning protrusion 240 can fit more tightly with the positioning groove 120.

It should be noted that in this embodiment, the positioning groove 120 is set as the best effect. In other embodiments, the shape and distribution of the positioning groove 120 are not limited, as long as it can achieve a magnetic fixation between the positioning groove 120 and the positioning blocks 110. There is no further limitation here.

Furthermore, the installation plates 100 are provided with a support column 101, so that a gap is provided between the positioning blocks 110 and the installation plates 100 through the support column 101. The storage block 210 is provided with a bent portion 250 that hooks and fits with the gap. In this embodiment, there is a gap between the installation plates 100 and the positioning blocks 110 through the support column 101 provided between the installation plates 100 and the positioning blocks 110. In an implementation mode, other structures can also be used to achieve this, and there is no further limitation here.

By inserting the bent portion 250 into the gap between the positioning blocks 110 and the installation plates 100, the connection between the storage block 210 and the positioning blocks 110 is more secure, thereby improving the stability of the entire storage mechanism and enabling stable storage of the item 300. The number of the support column 101 can also be a plurality of, and there is no further limitation here.

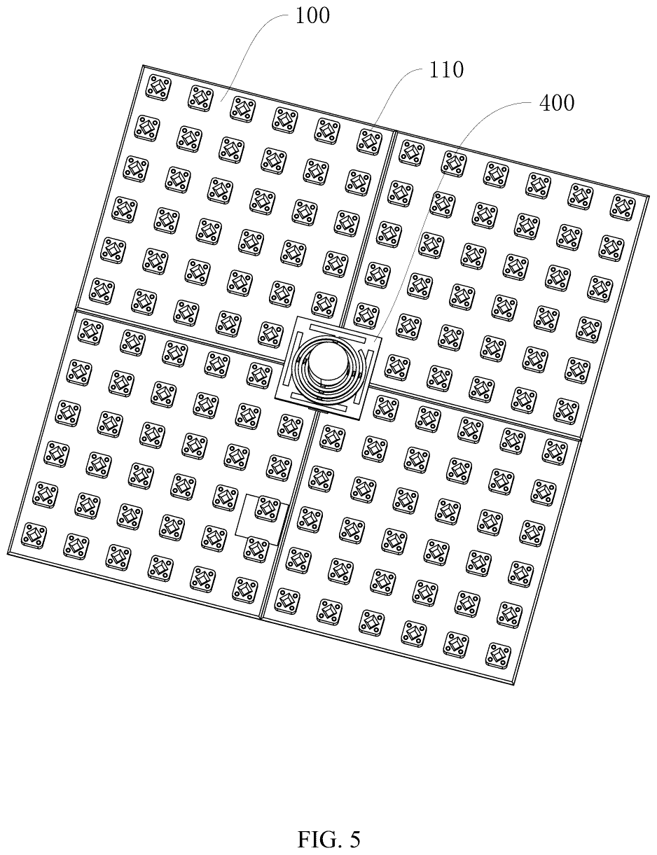

In addition, referring to FIGS. 5, 6, and 7, the storage mechanism provided in this embodiment further includes a locking component 400, which is configured to lock adjacent installation plates 100 to achieve a splicing of the plurality of installation plates 100.

In this embodiment, the locking component 400 is configured to lock four adjacent installation plates 100 to achieve the splicing of the plurality of installation plates 100, thereby meeting needs of a user. In an implementation mode, the locking component 400 can also splice adjacent two installation plates or other numbers of installation plates 100, without further limitation.

The locking component 400 includes:
an installation seat 410, fixedly provided between adjacent four installation plates 100;
four contact plates 420, the installation seat 410 is provided with sliding grooves 411 that cooperate with the four contact plates 420, so that the four contact plates 420 can move relative to the installation seat 410 in a direction of approaching or moving away from each other; and the four contact plates 420 are respectively configured to abut against the positioning blocks 110 on the four installation plates 100; and
a rotating block 430, configured to drive the four contact plates 420 to move towards or away from each other, so that the four contact plates 420 can respectively abut against side walls of the four positioning blocks 110; the rotating block 430 is connected to a center of the installation seat 410 through a screw thread, and a spiral disk 440 is fixedly provided below the rotating block 430; at least one sliding block 421 that cooperates with the gap of the spiral disk 440 is provided on the contact plates 420;
by driving the rotating block 430 to rotate, the spiral disk 440 is driven to rotate, the sliding block 421 is caused to slide within the gap of the spiral disk 440, thereby driving the four contact plates 420 to move towards each other and respectively abut against the four positioning blocks 110, thus achieving the splicing of the plurality of installation plates 100.

It can be understood that by driving the rotating block 430 to rotate, the spiral disk 440 is driven to rotate, and the sliding block 421 is caused to slide within the gap of the spiral disk 440, the four contact plates 420 are driven to move towards each other and respectively abut against the four positioning blocks 110, thus achieving the splicing of the plurality of installation plates 100. In practical applications, different sizes of installation plates 100 can be spliced according to different needs, which is flexible, versatile, applicable to various scenarios, and practical.

Furthermore, in order to enable the storage block 210 to stably store the item 300, the storage mechanism provided in this embodiment further includes a fixing component 500, which fixes the storage block 210 through the fixing component 500, so that the storage block 210 can stably store the item 300.

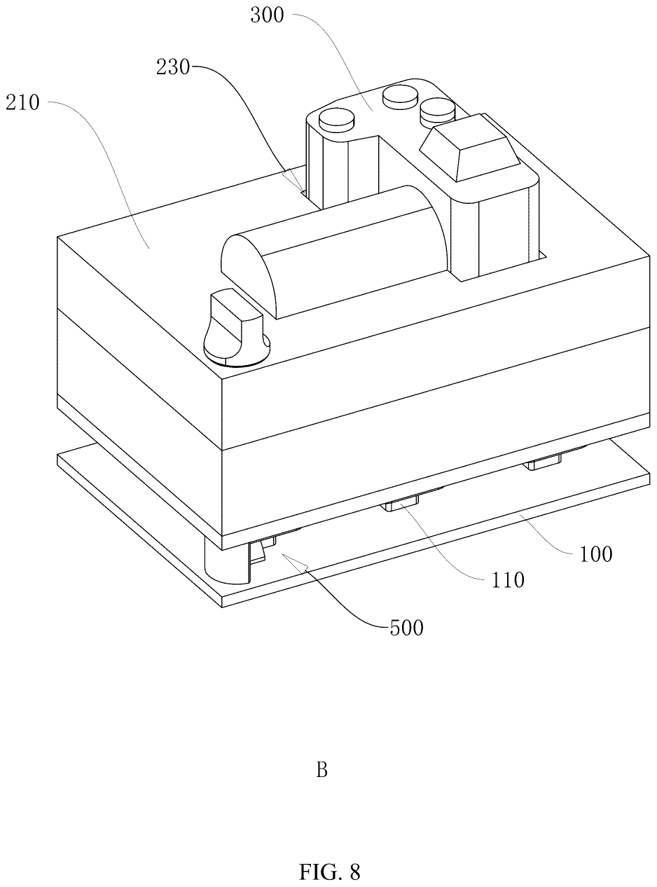

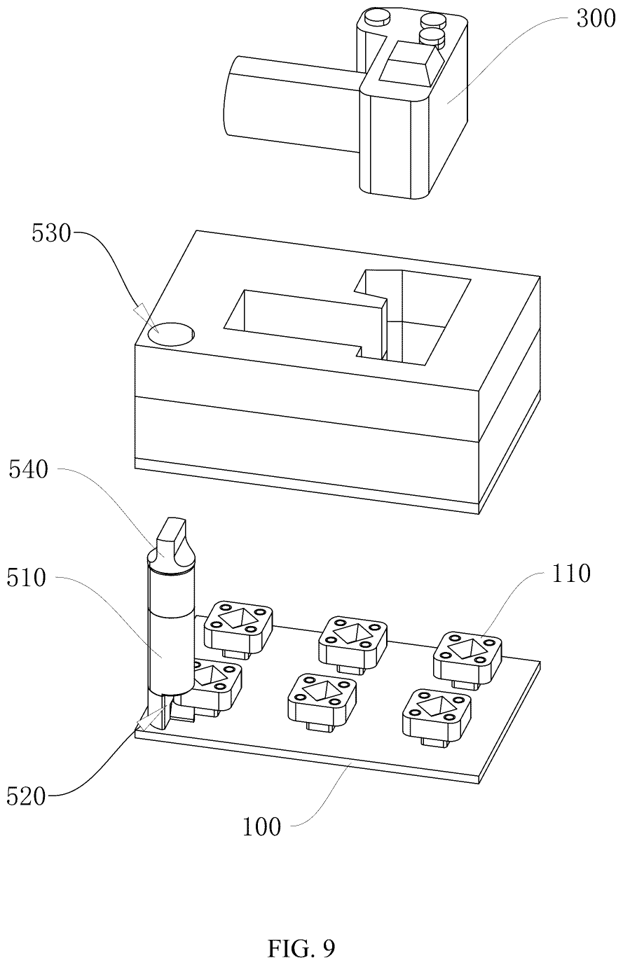

Specifically, referring to FIGS. 8 and 9, the fixing component 500 includes:
a rotating column 510, which is vertically and rotatably provided on the installation plates 100;
a rotating groove 520, which is provided on a side wall of the rotating column 510 for the positioning blocks 110 to enter and achieve a limit of the positioning blocks 110;
a fixing hole 530, which is vertically provided on the storage block 210, the fixing hole 530 penetrates the storage block 210 and is configured for the rotating column 510 to pass through, a top of the rotating column 510 is protruded from a top surface of the storage block 210;
a rotating head 540, which is fixedly provided at a top of the rotating column 510, located on a top surface of the storage block 210 and configured to drive the rotating column 510 to rotate.

By driving the rotating head 540 to rotate, the rotating column 510 is driven to rotate, the rotating groove 520 on the rotating column 510 is caused to rotate and the positioning blocks 110 to be accommodated in the rotating groove 520, thereby achieving a limit fixation of the positioning blocks 110, that is, the fixation of the storage block 210, and enabling the storage block 210 to stably store the items 300, thereby avoiding a situation where the storage block 210 is difficult to stably store the items 300 when it is in an inclined state or a vertical state.

This embodiment is used to provide a storage device. Referring to FIG. 8, in this embodiment, the items 300 stored in the storage device is a camera (which can also be other items in other embodiments). The storage device includes a storage container 600 and the unit type storage mechanism with a positioning structure as described above.

The above is only used to illustrate the technical solution of the present disclosure and not to limit it. Any other modifications or equivalent substitutions made by those skilled in the art to the technical solution of the present disclosure, as long as they do not depart from the spirit and scope of the technical solution of the present disclosure, should be included in the scope of the claims of the present disclosure.

What is claimed is:

1. A storage mechanism with a positioning structure, comprising:
a plurality of installation plates, surfaces of the installation plates are evenly distributed a plurality of positioning blocks, and a positioning groove is provided on one side of the positioning blocks facing away from the installation plates;
a storage unit, comprising at least one storage block, wherein a surface of the storage block is provided with a suspension part configured to hang to-be-stored items and/or a storage part configured to store the to-be-stored items, and at least one positioning protrusion that is adapt to the positioning groove and provided on one side of the storage block away from the suspension part and/or the storage part;
the positioning protrusion is detachably connected to the positioning groove through a magnetic suction member.

2. The storage mechanism with a positioning structure according to claim 1, wherein the magnetic suction member comprises two sets of magnets respectively provided on the positioning blocks and the positioning protrusion;
the two sets of magnets are arranged opposite to each other,
wherein one set of magnets are uniformly distributed on a circumferential side of the positioning groove, and the other set of magnets are uniformly distributed on a circumferential side of the positioning protrusion.

3. The storage mechanism with a positioning structure according to claim 2, wherein the magnets are arranged in a cylindrical shape;
opposite sides of the positioning blocks and the positioning protrusion are provided with magnet slots configured to accommodate the magnets.

4. The storage mechanism with a positioning structure according to claim 1, wherein the positioning groove is located at a center of the positioning blocks, and a cross-section of the positioning groove is gradually decreased from a groove mouth to an interior.

5. The storage mechanism with a positioning structure according to claim 1, wherein a support column is provided on the installation plates so that a gap is provided between the positioning blocks and the installation plates through the support column;
a bent portion is provided on the storage block to cooperate with the gap.

6. The storage mechanism with a positioning structure according to claim 1, wherein the storage mechanism further comprises a locking component configured to lock adjacent installation plates to achieve a splicing of the plurality of installation plates.

7. The storage mechanism with a positioning structure according to claim 6, wherein the locking component comprises:
an installation seat, fixedly provided between adjacent four installation plates;
four contact plates, the installation seat is provided with sliding grooves that cooperate with the contact plates, so that the four contact plates are capable of being moved relative to the installation seat in a direction of approaching or moving away from each other, and the four contact plates are respectively configured to abut against the positioning blocks on the four installation plates; and
a rotating block, configured to drive the four contact plates to move towards or away from each other, so that the four contact plates are capable of being respectively abutted against side walls of the four positioning blocks; the rotating block is connected to a center of the installation seat through a screw thread, and a spiral disk is fixedly provided below the rotating block; at least one sliding block that cooperates with the gap of the spiral disk is provided on the contact plates;
by driving the rotating block to rotate, the spiral disk is driven to rotate, the sliding block is caused to slide within the gap of the spiral disk, thereby driving the four contact plates to move towards each other and respectively abut against the four positioning blocks, thus achieving the splicing of the plurality of installation plates.

8. The storage mechanism with a positioning structure according to claim 1, wherein the storage mechanism further comprises a fixing component configured to fix the storage block, so that the storage block stores the to-be-stored items.

9. The storage mechanism with a positioning structure according to claim 8, wherein the fixing component comprises:
a rotating column, which is vertically and rotatably provided on the installation plates;
a rotating groove, which is provided on a side wall of the rotating column for the positioning blocks to enter and achieve a limit of the positioning blocks;
a fixing hole, which is vertically provided on the storage block, the fixing hole penetrates the storage block and is configured for the rotating column to pass through; a top of the rotating column is protruded from a top surface of the storage block;
a rotating head, which is fixedly provided at a top of the rotating column, located on a top surface of the storage block and configured to drive the rotating column to rotate.

10. A storage device, comprising a storage container and the storage mechanism with a positioning structure according to claim 1.
